(19) United States
(12) Patent Application Publication
(10) Pub. No.: US 2016/0305486 A1
(43) Pub. Date: Oct. 20, 2016

(54) LOCKING MECHANISM FOR DUAL MASS FLYWHEELS

(71) Applicant: BorgWarner Inc., Auburn Hills, MI (US)

(72) Inventor: Wesley L. Shaw, Rochester Hills, MI (US)

(21) Appl. No.: 14/687,347

(22) Filed: Apr. 15, 2015

(51) Int. Cl. F16D 3/14; F16F 15/131; F16D 3/10

(52) U.S. Cl. CPC F16D 3/14; F16D 3/10; F16F 15/13135

(57) ABSTRACT

A dual mass flywheel includes a first flywheel part arranged for rotation on an axis, a second flywheel part arranged for rotation on the axis, and a torsional damper that is connected to the first flywheel part and the second flywheel part. A linkage is connected to the first flywheel part and includes a first joint that is movable from a first position, in which a first joint of the linkage is in an over-center condition, to a second position. An engaging member is connected to the linkage such that the engaging member engages the second flywheel part when the linkage is in the first position and disengages from the second flywheel part when the linkage is in the second position.

### BACKGROUND

In its simplest form, a flywheel is simply a disc of significant mass that has a high moment of inertia. One function of the flywheel is to resist changes is rotational speed.

In the field of automobile powertrains, a flywheel is connected to the crankshaft of an internal combustion engine. Thus, in an internal combustion engine, the flywheel resists acceleration and deceleration of the crankshaft. This resistance to acceleration and deceleration reduces fluctuations in the rotational speed of the crankshaft that would otherwise be caused by linear reciprocal motion of the pistons. Without the flywheel, fluctuations in rotational speed in the crankshaft would cause potentially severe vibrations.

A dual mass flywheel includes two separate flywheel parts that are connected to one another by a torsional damper. The torsional damper connects the two flywheel parts such that relative rotation between them is allowed along the axis of rotation of the flywheel, with the torsional damper resisting relative rotation of the two flywheel parts and urging them to a rotationally neutral position.

Some dual mass flywheels include a mechanism that is configured to lock the two separate flywheel parts up to a threshold speed to reduce noise, vibration, and harshness during startup of the engine.

### SUMMARY

One aspect of the disclosed embodiments is a dual mass flywheel that includes a first flywheel part arranged for rotation on an axis, a second flywheel part arranged for rotation on the axis, and a torsional damper that is connected to the first flywheel part and the second flywheel part. A linkage is connected to the first flywheel part and includes a first joint that is movable from a first position, in which a first joint of the linkage is in an over-center condition, to a second position. An engaging member is connected to the linkage such that the engaging member engages the second flywheel part when the linkage is in the first position and disengages from the second flywheel part when the linkage is in the second position.

Another aspect of the disclosed embodiments is a dual mass flywheel that includes a first flywheel part arranged for rotation on an axis, a second flywheel part arranged for rotation on the axis, and a torsional damper that is connected to the first flywheel part and the second flywheel part. A linkage includes a first link that is pivotally connected to the first flywheel part, and a second link that is connected to the first link by a first joint that is movable from a first position, in which a first joint of the linkage is in an over-center condition, to a second position. An engaging member is connected to the linkage such that the engaging member engages the second flywheel part when the linkage is in the first position and disengages from the second flywheel part when the linkage is in the second position. Rotation of the first flywheel part urges the first joint of the linkage toward the second position such that the first joint of the linkage moves from the first position to the second position when a rotational speed of the first flywheel part exceeds a threshold speed. A spring urges the first joint toward the first position such that the first joint of the linkage moves from the second position to the first position when the rotational speed of the first flywheel part is below a threshold speed.

Another aspect of the disclosed embodiments is an automobile drivetrain that includes an engine that provides rotational driving power; a dual mass flywheel that receives the rotational driving power from the engine, and a transmission that receives the driving power from the dual mass flywheel. The dual mass flywheel includes a first flywheel part that is arranged for rotation on an axis, a second flywheel part that is arranged for rotation on the axis, and a torsional damper that is connected to the first flywheel part and the second flywheel part. The dual mass flywheel also includes a linkage having a first link that is pivotally connected to the first flywheel part and a second link that is connected to the first link by a first joint that is movable from a first position, in which a first joint of the linkage is in an over-center condition, to a second position. An engaging member is connected to the linkage such that the engaging member engages the second flywheel part when the linkage is in the first position and disengages from the second flywheel part when the linkage is in the second position. Rotation of the first flywheel part urges the first joint of the linkage toward the second position such that the first joint of the linkage moves from the first position to the second position when a rotational speed of the first flywheel part exceeds a threshold speed. A spring urges the first joint toward the first position such that the first joint of the linkage moves from the second position to the first position when the rotational speed of the first flywheel part is below a threshold speed.

### BRIEF DESCRIPTION OF THE DRAWINGS

The description herein makes reference to the accompanying drawings, wherein like referenced numerals refer to like parts throughout several views, and wherein:

FIG. 1 is a schematic illustration showing a portion of an automobile drivetrain;

FIG. 2 is a perspective view showing a dual mass flywheel;

FIG. 3 is a perspective view showing a locking mechanism according to a first example;

FIG. 4 is a front view showing the locking mechanism according to the first example, with the locking mechanism in an engaged position;

FIG. 5 is a perspective view showing a locking mechanism according to a second example; and

FIG. 6 is a front view showing a locking mechanism according to a third example.

### DETAILED DESCRIPTION

The disclosure herein is directed to a locking mechanism for dual mass flywheels. The locking mechanism described herein utilizes an over-center toggle lock to provide high holding force while keeping actuation force low.

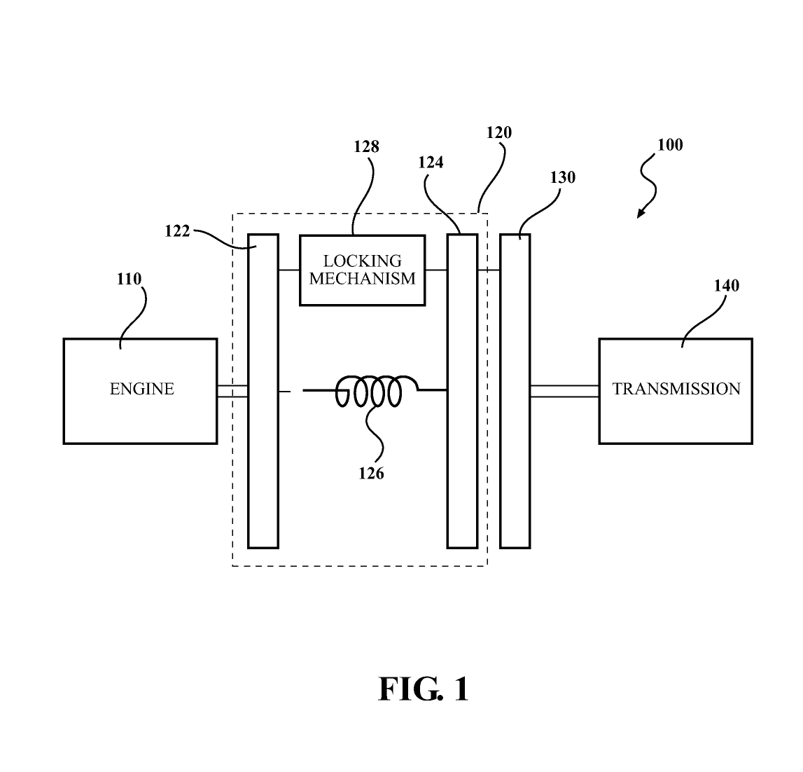

FIG. 1 is an illustration showing a portion of an automobile drivetrain 100 that includes an engine 110, a dual mass flywheel 120, a clutch 130, and a transmission 140.

The engine 110 is conventional, and can be an internal combustion engine such as a linear reciprocating piston internal combustion engine. The clutch 130 is a conventional selective torque transmission device can be a manually operated or electronically controlled. The clutch 130 can have an engaged position, in which it transmits rotational driving power, and a disengaged position, in which rotational driving power is not transmitted. In some implementations, the clutch 130 is omitted. The transmission 140 is conventional speed and torque conversion device such as a manual transmission, an electronically controlled manual transmission, an automatic transmission, or a continuously variable transmission.

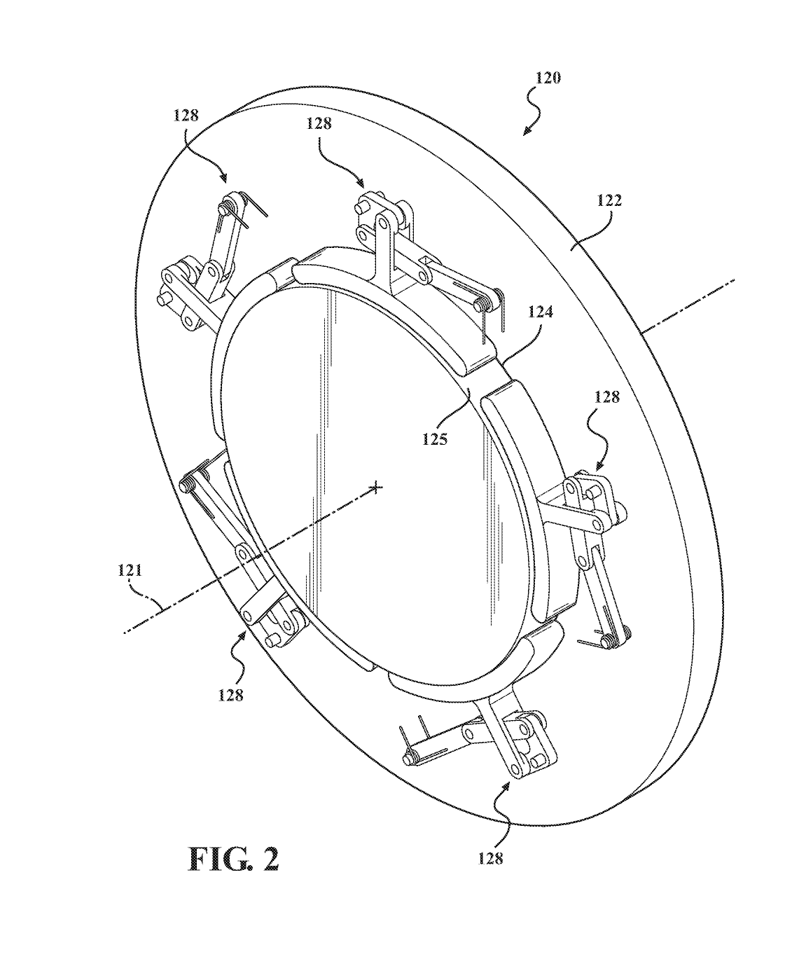

The dual mass flywheel 120 includes a first flywheel part 122 and a second flywheel part 124. The first flywheel part 122 and the second flywheel part 124 rotate on an axis of rotation 121 (FIG. 2) in response to rotational driving power received from the engine 110. The first flywheel part 122 receives rotational driving power directly from the engine 110, such as by a connection to the crankshaft of the engine 110 that causes rotation of the first flywheel part 122 in unison with the crankshaft. The second flywheel part 124 is connected to the first flywheel part 122 by a torsional damper 126. The torsional damper 126 connects the first flywheel part 122 to the second flywheel part 124 such that relative rotation of the second flywheel part 124 with respect to the first flywheel part 122 s allowed along the axis of rotation 121 over a limited angular range of motion. The torsional damper 126 resists this relative rotation and urges the second flywheel part 124 toward a rotationally neutral position with respect to the first flywheel part 122. The torsional damper 126 is conventional, and can be of any currently known design or any later developed design.

In order to prevent relative rotation of the second flywheel part 124 with respect to the first flywheel part 122 under certain conditions, the dual mass flywheel 120 includes one or more locking mechanisms 128. For example, the locking mechanism can move between a locked position in which the second flywheel part 124 rotates in unison with the first flywheel part 122, and an unlocked position in which relative rotation of the second flywheel part 124 with respect to the first flywheel part 122 is permitted, as controlled by the torsional damper 126. Movement of the locking mechanism 128 between the locked and unlocked positions can be responsive to the rotational speed of the dual mass flywheel 120, as will be explained further herein.

The automobile drivetrain 100 is an example of an implementation in which the dual mass flywheel 120 can be used. In this example, rotational driving power from the engine 110 is delivered to the dual mass flywheel 120 such as by a crankshaft (not shown) of the engine 110. The driving power is then provided to the clutch 130. The clutch 130, when in its engaged position, delivers the driving power to the transmission 140. Additional components (not shown) can be incorporated in the automobile drivetrain 100 to deliver the driving power from the transmission 140 to the wheels of the automobile. Other drivetrain configurations can be utilized in conjunction with the dual mass flywheel 120, including ones in which additional components are interposed between the components included in the illustrated example.

FIG. 2 shows the dual mass flywheel 120 with portions omitted in order to show the locking mechanisms 128. The locking mechanisms 128 can be arranged in a radial array around the axis of rotation 121. In the illustrated example, five of the locking mechanisms 128 are included in the dual mass flywheel 120 at a 72 degree center-to-center angular spacing. Other numbers of the locking mechanisms 128 could be include in the dual mass flywheel 120, such as six of the locking mechanisms 128 as a 60 degree center-to-center spacing. As noted previously the locking mechanisms 128 are each fixed to the first flywheel part 122 and engageable with the second flywheel part 124, in this example by engagement with an annular surface 125 that faces radially outward.

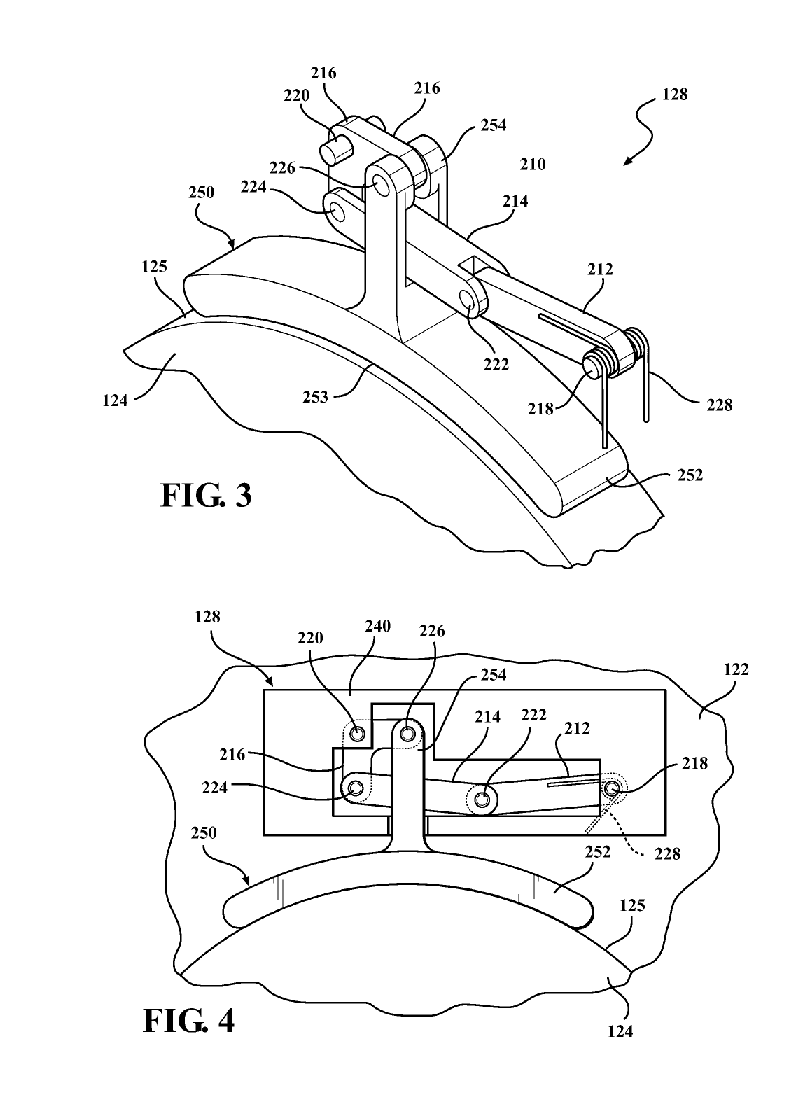

As best seen in FIGS. 3-4, each of the locking mechanisms 128 includes a linkage 210 that is disposed within a respective housing 240 of the first flywheel part 122 and an engaging member 250. Each housing 240 is fixed with respect to the first flywheel part 122 and can be an integral portion of the first flywheel part 122.

The linkage 210 can include a plurality of links such as a first link 212, a second link 214, and a third link 216.The linkage 210 is connected to the first flywheel part 122 in one or more locations, and these connections can be pivotal connections of the linkage 210 to the first flywheel part 122. In the illustrated example, the linkage 210 is pivotally connected to the first flywheel part 122 at a first pin 218 and a second pin 220. The first pin 218 and the second pin 220 can be any structure that allows a pivoting connection of two parts.

The first link 212 is connected to the first flywheel part 122 by the first pin 218 adjacent to a first end of the first link 212. This connection allows pivoting of the first link 212 on the axis of the first pin 218, but restrains translation of the first end of the first link 212 with respect to the first flywheel part 122.

At a second end of the first link 212, the first link 212 is connected to a first end of the second link 214 at a first pivot joint 222. The first pivot joint 222 allows pivoting of the first link 212 with respect to the second link 214 and vice versa. The first pivot joint 222 is not fixed to the first flywheel part 122 or the second flywheel part 124. On the contrary, the first pivot joint 222 is able to move in a circular arc centered on the first pin 218, with its range of motion being constrained by the second link 214 and engagement of the linkage 210 with the housing 240.

The third link 216 is connected to the first flywheel part 122 by the second pin 220. This connection allows pivoting of the third link 215 on the axis of the second pin 220, but restrains movement of the third link 215 with respect to the first flywheel part 122 other than pivoting, because the second pin 220 is connected to the first flywheel part 122.

The third link 216 is also connected to the second link 214 by a second pivot joint 224 and to the engaging member 250 by a third pivot joint 226. The second pivot joint 224 and the third pivot joint 226 are not connected to the first flywheel part 122 or the second flywheel part 124 and thus are able to translate with respect to the first flywheel part 122 and the second flywheel part 124. The second pivot joint 224 and the third pivot joint 226 are both spaced radially outward from the axis of the second pin 220. Thus, the second pivot joint 224 and the third pivot joint 226 each move in circular arcs over a limited range of motion in response to pivoting of third link 216 on the axis of the second pin 220.

In the illustrated example, the second pivot joint 224 and the third pivot joint 226 are spaced angularly by approximately 90 degrees with respect to the axis of the second pin 220, and each is spaced from the second pin 220 by a similar radial distance. As a result, the third link 216 can be formed as an L-shaped member. It should be understood, however, that the relative positions of the second pivot joint 224 and the third pivot joint 226 need not be as illustrated, and that the third link 216 need not be an L-shaped member.

The engaging member 250 is connected to the linkage 210 and is configured to engage the second flywheel part 124 of the dual mass flywheel 120. In particular, the linkage 210 connects the engaging member 250 to the first flywheel part 122 and causes movement of the engaging member 250 between engagement with the second flywheel part 124 and disengagement with the second flywheel part 124. Engagement of the engaging member 250 with the second flywheel part 124 corresponds to the locked position of the locking mechanism 128. Disengagement of the engaging member 250 from the second flywheel part 124 corresponds to the unlocked position of the engaging member 250. The locked and unlocked positions of the engaging member 250 may, therefore, also be referred to as engaged and disengaged positions of the engaging member 250.

The engaging member 250 includes an engaging shoe portion 252 and a connecting rod portion 254. The connecting rod portion 254 extends from a first end at the engaging shoe portion 252 to a second end of the connecting rod portion 254 that is located radially outward from the engaging shoe portion 252. At the second end of the connecting rod portion 254, the connecting rod portion 254 is connected to the third link 216 by the third pivot joint 226, as previously noted.

The engaging shoe portion 252 is positioned adjacent to the annular surface 125. The engaging shoe portion includes an arcuate surface 253 that is on a radially inward side of the engaging shoe portion 252, opposite the connecting rod portion 254, which is on a radially outward side of the engaging shoe portion 252. The arcuate surface 253 of the engaging shoe portion 252 faces the annular surface 125 and is the portion of the engaging member 250 that is engaged with the annular surface 125 of the second flywheel part 124 when the linkage 210 is in the engaged position. Accordingly, the curvature of the arcuate surface 253 of the engaging shoe portion 252 is complementary to the curvature of the annular surface 125 of the second flywheel part 124. When the linkage 210 moves to the disengaged position, the arcuate surface 253 disengages from the annular surface 125, as the engaging shoe portion 252 moves radially outward away from the annular surface 125 of the second flywheel part 124.

In order to urge the linkage 210 toward the engaged position, the linkage 210 includes a spring 228. The spring 228 is engaged with the spring and with a structure that is fixed to the first flywheel part 122, such as the housing 240. It should be noted that the term spring is intended to encompass all classes of structures that are able to deform from a neutral position when a force is applied to it and then resiliently return to the neutral position when the force is removed. In the illustrated example, the spring 228 includes a pair of torsion springs that are seated on the first pin 218 and engage the first link 214 as well as the housing 240. Other types of springs and other spring locations can be used to urge the first pivot joint 222 in the manner described herein.

The spring 228 causes the first pivot joint 222 to move in a direction that is generally toward the axis of rotation 121, with the extent of this movement being limited, such as by the range of motion of the second pivot joint 224 or by engagement of a portion of the linkage 210 upon the housing 240 or other structure. In this position, the first pivot joint 222 is placed into an over-center position. In particular, during movement from the disengaged position to the engaged position, the first pivot joint 222 moves past a centered position, at which the first link 212 and the second link 214 are aligned and extend in a generally tangential direction relative to the first flywheel part 122, and the distance from the first pin 218 to the second pivot joint 224 is at its maximum possible value. At this point, the arcuate surface 253 of the engaging member 250 is in engagement with the annular surface 125 of the second flywheel part 124. As the first pivot joint 222 continues from the centered position to the engaged position, in which the first pivot joint is over-center, the distance from the first pin 218 to the second pivot joint 224 decreases slightly, and the arcuate surface 253 of the engaging member 250 loosens very slightly with respect to the annular surface 125.

In operation, when the dual mass flywheel 120 is at rest, each of the locking mechanisms 128 of the dual mass flywheel 120 will be engaged. Engagement of the locking mechanisms 128 restrains rotation of the second flywheel part 124 relative to the first flywheel part 122. Accordingly, the torsional damper 126 is not initially utilized.

As the dual mass flywheel 120 begins to rotate under the influence of the internal combustion engine 110, the locking mechanisms 128 remain engaged, and the first flywheel part 122 rotates in unison with the second flywheel part. As the dual mass flywheel 120 reaches a threshold rotational speed, the locking mechanisms 128 disengage. In particular, the locking mechanisms 128 disengage by movement of the first link 212 and the second link 214 such that the first pivot joint 222 moves from the engaged position past the centered position to the disengaged position. The threshold speed is the speed at which the centrifugal force acting on the first pivot joint 222 of the linkage 210 of each of the locking mechanisms 128 is sufficient to overcome the biasing force exerted upon the first pivot joint 222 by the spring 228. The locking mechanisms 128 remain disengaged while the rotational speed of the dual mass flywheel 120 remains above the threshold speed. While the locking mechanisms 128 remain disengaged, the second flywheel part 124 is able to rotate slightly with respect to the first flywheel part 122 via the torsional damper 126 in order to smooth changes in rotational speed.

When the rotational speed of the dual mass flywheel 120 decreases below the threshold speed, the biasing force of the spring 228 urges the first pivot joint 222 toward the engaged position. As the first pivot joint 222 moves to the engaged position from the disengaged position, the first link 212 and the second joint link past their centered condition before reaching the engaged position, thereby placing the first pivot joint 222 and the portion of the linkage that includes the first link 212, the first pivot joint 222, and the second link 214 in an over-center position.

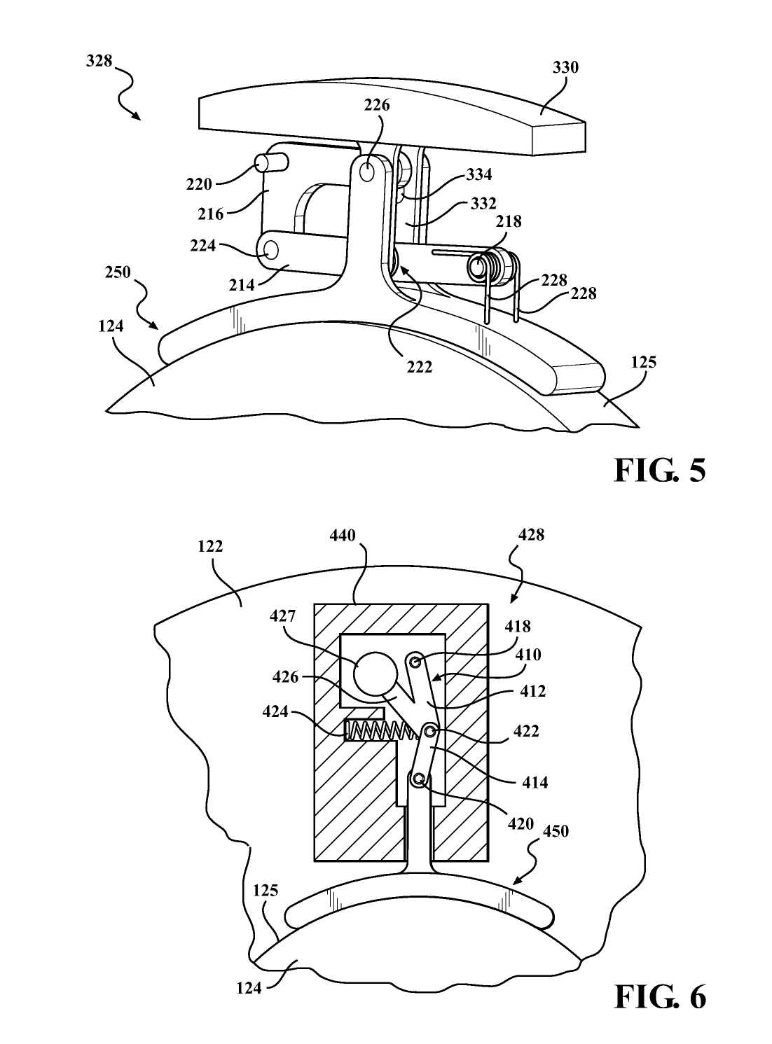

FIG. 5 is a perspective view showing a locking mechanism 328, which is similar to the locking mechanism 128 and operates and is used in the same manner, except as otherwise noted herein. In this example, the first pivot joint 222 and the third pivot joint 226 are radially aligned. The locking mechanism 328 includes a body 330 that is connected to the first pivot joint 222 by a split link 332. The split link 332 can be formed integrally with the body 330. Slots 334 are formed in each portion of the split link, which allows the split link 332 to be slidably connected to the third pivot joint 226, with the third link 216 disposed between the two parts of the split link 332, and the split link 332 disposed between two opposed parts of the rod portion 254, which also has a split configuration. This configuration allows that slots 334 to slide at the third pivot joint 226 as the body 330 moves radially along with movement of the first pivot joint 222. The body 330 provides additional mass that acts directly at the first pivot joint 222 to cause movement of the first pivot joint 222 toward the second position. By adjusting the mass of the body 330, the threshold rotational speed for engagement and disengagement of the locking mechanism 328 can be controlled. Operation of the locking mechanism 328 is as described with respect to the locking mechanism 128.

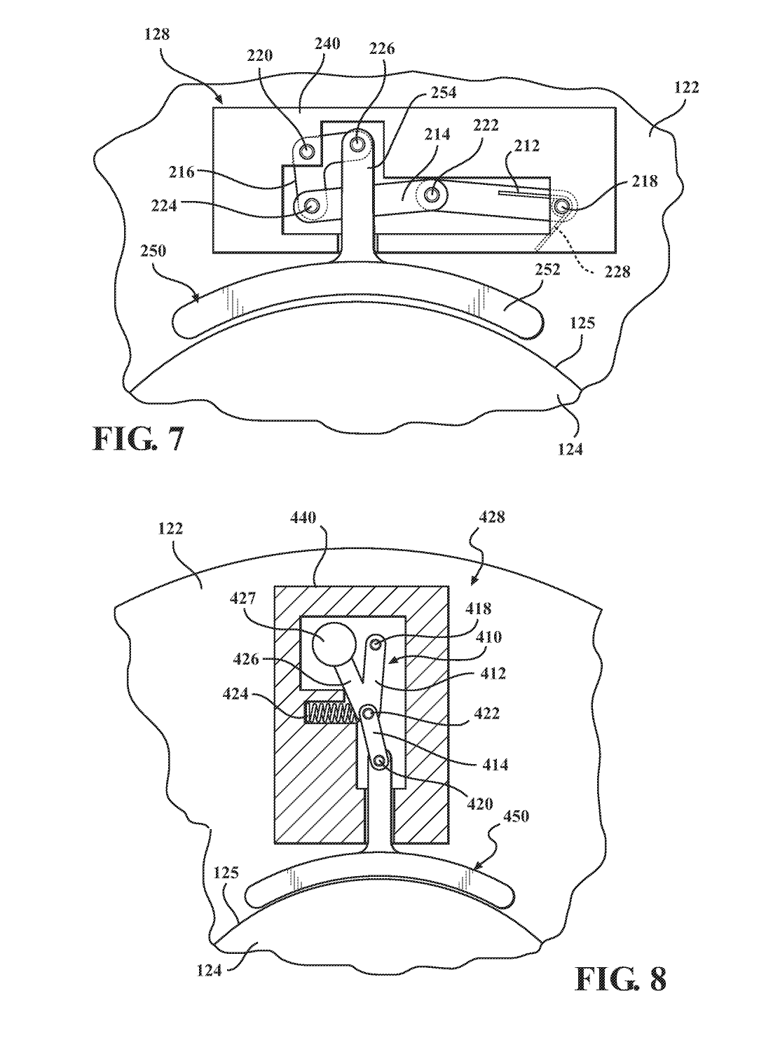

FIG. 6 is a front view showing a locking mechanism 428, which is similar to the locking mechanism 128 and operates and is used in the same manner, except as otherwise noted herein. In this example, a linkage 410 includes a first link 412 and a second link 414 that extend in a generally radial direction when in their centered (maximum length) position. A first pin 418 connects the first link 412 to the first flywheel part 122. The first link 412 is connected to the second link 414 by a first pivot joint 422. The second link 414 is connected to an engaging member 450 by a second pivot joint 424. The first pivot joint 422 and the second pivot joint 422 are able to move with respect to the first flywheel part 122, subject to limitations in their respective ranges of motion imposed by the first pin 418 and interaction of the linkage 410 and the engaging member 450 with a housing 440. The locking mechanism 428 omits the third link as in the locking mechanism 128. A spring 424, which in this case is a tangentially-oriented compression spring, acts on the first pivot joint 422 to place the linkage 410 in an over-center position and thereby move the locking mechanism 428 to an engaged position.

The linkage 410 includes A fixed link 426 extends outward from the first link 412 by an angle relative to the radial direction. The fixed link 426 is fixed with respect to the first link 412 and moves in unison with the first link 412. The fixed link 426 can be fixedly connected to the first link 412 or can be formed integrally with the first link 412. The fixed link 426 is connected to a body 427 at the ends opposite the first link 412. The body 427 acts on the first pivot joint 422 during rotation of the first flywheel part 122 to urge the first pivot joint 422 against the force exerted by the spring 424, to move the locking mechanism 428 toward the disengaged position. The mass of the body 427 and the angle at which the body 427 extends from the first link 412 control the threshold rotational speed at which the first pivot joint 422 moves to cause the locking mechanism 428 to move from the engaged position to the disengaged position. Movement of the first pivot joint 422 between the engaged and disengaged positions is in a generally tangential direction relative to the first flywheel part 422. Operation of the locking mechanism 428 is as described with respect to the locking mechanism 128.

While the disclosure has been made in connection with what is presently considered to be the most practical and preferred implementation, it should be understood that the disclosure is intended to cover various modifications and equivalent arrangements.

1. A dual mass flywheel, comprising:
a first flywheel part arranged for rotation on an axis;
a second flywheel part arranged for rotation on the axis;
a torsional damper that is connected to the first flywheel part and the second flywheel part;
a linkage that is connected to the first flywheel part and includes a first joint that is movable from a first position to a second position, wherein the linkage includes a first link that is pivotally connected to the first flywheel part, and a second link that is pivotally connected to the first link by the first joint; and
an engaging member that is connected to the linkage such that the engaging member engages the second flywheel part when the linkage is in the first position and disengages from the second flywheel part when the linkage is in the second position.

2. The dual mass flywheel of claim 1, wherein rotation of the first flywheel part urges the first joint of the linkage toward the second position.

3. The dual mass flywheel of claim 1, wherein the first joint of the linkage moves from the first position to the second position when a rotational speed of the first flywheel part exceeds a threshold speed.

4. The dual mass flywheel of claim 1, wherein the first joint moves in a generally radial direction between the first position and the second position.

5. The dual mass flywheel of claim 1, further comprising:
a spring that urges the first joint toward the first position.

6-7. (canceled)

8. A dual mass flywheel, comprising:
a first flywheel part arranged for rotation on an axis;
a second flywheel part arranged for rotation on the axis;
a torsional damper that is connected to the first flywheel part and the second flywheel part;
a linkage that is connected to the first flywheel part and includes a first joint that is movable from a first position to a second position, wherein the linkage includes a first link that is pivotally connected to the first flywheel part, and a second link that is connected to the first link by the first joint; and
an engaging member that is connected to the linkage such that the engaging member engages the second flywheel part when the linkage is in the first position and disengages from the second flywheel part when the linkage is in the second position, wherein the second link is connected to the engaging member.

9. The dual mass flywheel of claim 7, wherein the second link is connected to a third link by a second joint, the third link is pivotally connected to the first flywheel part, and the third link is pivotally connected to the engaging member by a third joint.

10. The dual mass flywheel of claim 7, wherein the first link and the second link extend in a generally tangential direction relative to the first flywheel part.

11. A dual mass flywheel, comprising:
a first flywheel part arranged for rotation on an axis;
a second flywheel part arranged for rotation on the axis;
a torsional damper that is connected to the first flywheel part and the second flywheel part;
a linkage that is connected to the first flywheel part and includes a first joint that is movable from a first position to a second position, wherein the linkage includes a first link that is pivotally connected to the first flywheel part, a second link that is connected to the first link by the first joint, and the first link and the second link extend in a generally radial direction relative to the first flywheel part; and
an engaging member that is connected to the linkage such that the engaging member engages the second flywheel part when the linkage is in the first position and disengages from the second flywheel part when the linkage is in the second position.

12. The dual mass flywheel of claim 1, wherein the engaging member includes an arcuate surface that is engageable with an annular surface of the second flywheel part.

13. A dual mass flywheel, comprising:
a first flywheel part arranged for rotation on an axis;
a second flywheel part arranged for rotation on the axis;
a torsional damper that is connected to the first flywheel part and the second flywheel part;
a linkage that includes a first link that is pivotally connected to the first flywheel part, and a second link that is pivotally connected to the first link by a first joint that is movable from a first position to a second position;
an engaging member that is connected to the linkage such that the engaging member engages the second flywheel part when the linkage is in the first position and disengages from the second flywheel part when the linkage is in the second position, wherein rotation of the first flywheel part urges the first joint of the linkage toward the second position such that the first joint of the linkage moves from the first position to the second position when a rotational speed of the first flywheel part exceeds a threshold speed; and
a spring that urges the first joint toward the first position such that the first joint of the linkage moves from the second position to the first position when the rotational speed of the first flywheel part is below a threshold speed.

14. The dual mass flywheel of claim 13, wherein the first joint moves in a generally radial direction between the first position and the second position.

15. A dual mass flywheel, comprising:
a first flywheel part arranged for rotation on an axis;
a second flywheel part arranged for rotation on the axis;
a torsional damper that is connected to the first flywheel part and the second flywheel part;
a linkage that includes a first link that is pivotally connected to the first flywheel part, and a second link that is connected to the first link by a first joint that is movable from a first position to a second position;
an engaging member that is connected to the linkage such that the engaging member engages the second flywheel part when the linkage is in the first position and disengages from the second flywheel part when the linkage is in the second position, wherein rotation of the first flywheel part urges the first joint of the linkage toward the second position such that the first joint of the linkage moves from the first position to the second position when a rotational speed of the first flywheel part exceeds a threshold speed, wherein the second link is connected to the engaging member; and
a spring that urges the first joint toward the first position such that the first joint of the linkage moves from the second position to the first position when the rotational speed of the first flywheel part is below a threshold speed.

16. The dual mass flywheel of claim 13, wherein the second link is connected to a third link by a second joint, the third link is pivotally connected to the first flywheel part, and the third link is pivotally connected to the engaging member by a third joint.

17. The dual mass flywheel of claim 13, wherein the first link and the second link extend in a generally tangential direction relative to the first flywheel part.

18. A dual mass flywheel, comprising:
a first flywheel part arranged for rotation on an axis;
a second flywheel part arranged for rotation on the axis;
a torsional damper that is connected to the first flywheel part and the second flywheel part;
a linkage that includes a first link that is pivotally connected to the first flywheel part, and a second link that is connected to the first link by a first joint that is movable from a first position to a second position, wherein the first link and the second link extend in a generally radial direction relative to the first flywheel part;
an engaging member that is connected to the linkage such that the engaging member engages the second flywheel part when the linkage is in the first position and disengages from the second flywheel part when the linkage is in the second position, wherein rotation of the first flywheel part urges the first joint of the linkage toward the second position such that the first joint of the linkage moves from the first position to the second position when a rotational speed of the first flywheel part exceeds a threshold speed; and
a spring that urges the first joint toward the first position such that the first joint of the linkage moves from the second position to the first position when the rotational speed of the first flywheel part is below a threshold speed.

19. The apparatus of claim 13, wherein the engaging member includes an arcuate surface that is engageable with an annular surface of the second flywheel part.

20. An automobile drivetrain, comprising:
an engine that provides rotational driving power;
a dual mass flywheel that receives the rotational driving power from the engine and includes:
a first flywheel part arranged for rotation on an axis,
a second flywheel part arranged for rotation on the axis,
a torsional damper that is connected to the first flywheel part and the second flywheel part,
a linkage that includes a first link that is pivotally connected to the first flywheel part, and a second link that is pivotally connected to the first link by a first joint that is movable from a first position to a second position;
an engaging member that is connected to the linkage such that the engaging member engages the second flywheel part when the linkage is in the first position and disengages from the second flywheel part when the linkage is in the second position, wherein rotation of the first flywheel part urges the first joint of the linkage toward the second position such that the first joint of the linkage moves from the first position to the second position when a rotational speed of the first flywheel part exceeds a threshold speed, and
a spring that urges the first joint toward the first position such that the first joint of the linkage moves from the second position to the first position when the rotational speed of the first flywheel part is below a threshold speed; and
a transmission that receives the driving power from the dual mass flywheel.

21. The automobile drivetrain of claim 20, wherein the first joint of the linkage is in an over-center condition when the linkage is in the first position.

22. The dual mass flywheel of claim 1, wherein the first joint of the linkage is in an over-center condition when the linkage is in the first position.

23. The dual mass flywheel of claim 13, wherein the first joint of the linkage is in an over-center condition when the linkage is in the first position.
